(19) United States
(12) Patent Application Publication
(10) Pub. No.: US 2026/0140902 A1
(43) Pub. Date: May 21, 2026

(54) TRIPLE PLUG UNIVERSAL SERIAL BUS (USB) CABLE FOR USE WITH DATA STORAGE DEVICE WITH DUAL MEMORY SPACES

(71) Applicant: Sandisk Technologies, Inc., Milpitas, CA (US)

(72) Inventors: Ankur Agrawal, Bangalore (IN); Sudhan Immanuel Godwin, Bangalore (IN); Varun Gopal, Bangalore (IN); Vinay Vijay Shetgaonkar, Mapusa (IN)

(21) Appl. No.: 19/361,950

(22) Filed: Oct. 17, 2025

Related U.S. Application Data
(63) Continuation-in-part of application No. 18/954,904, filed on Nov. 21, 2024.

(51) Int. Cl. G06F 13/38; G06F 13/42

(52) U.S. Cl. CPC G06F 13/382; G06F 13/4282; G06F 2213/0042

(57) ABSTRACT

A three-plug Universal Serial Bus (USB) cable enables a portable storage device to be connected to two USB sockets of a host to allow the host to concurrently access two memory spaces within the storage device via two USB SuperSpeed communication lanes. The three-plug cable connects the first communication lane within the cable (e.g., TX1/RX1 lines) between a single USB-C socket of the storage device and a first USB-C socket of the host to enable the host to access a first memory space of the storage device via a first data storage controller of the device. The cable also concurrently connects the second communication lane within the cable (e.g., TX2/RX2 lines) between the same USB-C socket of the storage device and a second USB-C socket of the host to enable the host to concurrently access a second memory space of the storage device via a second controller of the device.

This application is a continuation-in-part (CIP) of U.S. patent application Ser. No. 18/954,904, filed Nov. 21, 2024, having Attorney Docket No. WDT-1462 (WDA-7823-US), entitled “DATA STORAGE DEVICE WITH DUAL MEMORY SPACES ENABLED BASED ON THE MATING ORIENTATION OF A REVERSIBLE CONNECTOR,” the entire contents of which is incorporated herein by reference.

### FIELD

The disclosure relates, in some aspects, to connection cables for connecting data storage devices such as solid state drives (SSDs) to a host. More specifically, but not exclusively, the disclosure relates to connection cables having one or more Universal Serial Bus (USB) Type-C connectors for connecting an SSD or other data storage device to a host.

### INTRODUCTION

In consumer electronics, solid state drives (SSDs) or other data storage devices incorporating non-volatile memories (NVMs) are often replacing or supplementing conventional hard disk drives for mass storage. The non-volatile memories may include one or more flash memory devices, such as NAND flash memories. The NVMs may also include multiple NAND flash dies or chips that form the NVM. Other data storage devices employ volatile memory such as dynamic random access memory (DRAM). Within SSDs and other data storage devices, it is important to maximize drive capacity without significantly increasing costs or power consumption. It is also important to provide connection cables for connecting such SSDs to a host while enabling convenient high speed access to the storage spaces within the SSD. Herein, connection cables, systems, methods and apparatus are provided to that end.

### SUMMARY

The following presents a simplified summary of some aspects of the disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One embodiment of the disclosure provides cable for connecting a data storage device to a host. The cable includes: first and second communication lanes, each configured for data transfer at 5 giga-bits-per-second (Gbps) or higher (e.g. SuperSpeed) in accordance with a Universal Serial Bus (USB) protocol (where, herein, a “communication lane” is a set of wires for transmitting and/or receiving data or other signals); a first plug connected to the first communication lane for insertion into a first connection socket of the host; a second plug connected to the second communication lane for insertion into a second connection socket of the host; and a third plug connected to both the first and second communication lanes for insertion into a connection socket of the storage device, the third plug being reversible. For example, the cable is a Y-cable or T-cable. In some examples, all three plugs are reversible USB Type-C plugs. In some examples, either the first plug or the second plug or both can be non-reversible USB Type-A plugs (9-pin or 4-pin) while the third plug is a reversible USB Type-C plug. In some aspects, the cable can additionally or alternatively transfer data at 12 mega-bits-per-second (Mbps) or 480 Mbps in accordance with USB 2.0 using, for example, a third communication lane (e.g., D+/D−) or by transferring data using the first and second communication lanes at 12 Mbps or 480 Mbps. In some aspects, power may be drawn from the host using both the first and second sockets of the host. The data storage device may be any type of data storage device, such as a solid state drive (SSD), hard disk drive (HDD), hybrid SSD/HDD drive, USB drive (e.g., flash drive or thumb drive), etc.

Another embodiment of the disclosure provides a method for use by a connection cable to connect a data storage device to a host, wherein the connection cable includes first and second communication lanes, each configured for data transfer at 5 Gbps or higher in accordance with a USB protocol. The method includes: receiving first data signals from a first connection socket of the host into a first plug of the cable that is connected to the first communication lane of the cable; receiving second data signals from a second connection socket of the host into a second plug of the cable that is connected to the second communication lane of the cable; routing the first data signals at 5 Gbps or higher from the first plug of the cable to the data storage device along the first communication lane of the cable to a third plug that is connected into a connection socket of the data storage device, the third plug being reversible; and routing the second data signals at 5 Gbps or higher from the second plug of the cable to the data storage device along the second communication lane of the cable to the third plug that is connected into the connection socket of the data storage device.

Yet embodiment of the disclosure provides a connection cable for connecting a data storage device to a host. The connection cable includes: means for receiving first data signals from a first connection socket of the host; means for receiving second data signals from a second connection socket of the host; means for transferring the first data signals along the connection cable at 5 Gbps or higher in accordance with a USB protocol; means for transferring the second data signals along the connection cable at 5 Gbps or higher in accordance with the USB protocol; and means for transferring the first and second data signals into a connection socket of the data storage device.

### BRIEF DESCRIPTION OF THE DRAWINGS

FIG. 1 is a schematic block diagram configuration for an exemplary solid state device (SSD) and USB-C connection port socket, according to the prior art.

FIG. 2A is a schematic diagram of a USB-C socket, according to the prior art.

FIG. 2B is a schematic diagram of a USB-C plug, according to the prior art.

FIG. 3 is a schematic block diagram of an exemplary SSD and USB-C connection port socket, wherein the SSD has dual memory spaces and dual data storage controllers, wherein only one of memory spaces is accessible by a host at any given time depending upon the USB-C plug/socket mating orientation, in accordance with aspects of the present disclosure.

FIG. 4A is a schematic diagram of an SSD with a USB-C plug/socket in a first mating orientation that provides access to a host to a first set of NAND chips, in accordance with aspects of the present disclosure.

FIG. 4B is a schematic diagram of an SSD with the USB-C plug/socket in a second, opposite mating orientation that provides access to the host to a second set of NAND chips, in accordance with aspects of the present disclosure.

FIG. 5A is a schematic diagram of an SSD with a USB-C plug/socket in a first mating orientation that illustrates a use case wherein a user accesses a first set of NAND chips to store work (or official) data, in accordance with aspects of the present disclosure.

FIG. 5B is a schematic diagram of an SSD with the USB-C plug/socket in a second mating orientation that illustrates a use case wherein a user accesses a second set of NAND chips to store personal data, in accordance with aspects of the present disclosure.

FIG. 6 is a block diagram of a system including a host, a USB-C connection cable, and an SSD, wherein the SSD has dual memory spaces and dual data storage controllers, wherein only one of memory spaces is accessible by a host at any given time depending upon the USB-C plug/socket mating orientation, in accordance with aspects of the present disclosure.

FIG. 7 is a schematic block diagram configuration for an exemplary apparatus, such as an SSD, configured according to aspects of the present disclosure.

FIG. 8 is a schematic block diagram configuration for an exemplary data storage device configured according to aspects of the present disclosure.

FIG. 9 illustrates an exemplary procedure according to aspects of the present disclosure.

FIG. 10 is a schematic block diagram configuration of a USB-C three-plug “Y-cable” for connecting an SSD to a host according to aspects of the present disclosure.

FIG. 11 is a schematic block diagram configuration of the communication lanes and pinouts of a USB-C three-plug Y-cable connecting an SSD to a host according to aspects of the present disclosure.

FIG. 12 is a circuit schematic block diagram of a first host-side cable plug of the USB-C three-plug Y-cable according to aspects of the present disclosure.

FIG. 13 is a circuit schematic block diagram of a second host-side cable plug of the USB-C three-plug Y-cable according to aspects of the present disclosure.

FIG. 14 is a circuit schematic block diagram of a device-side cable plug of the USB-C three-plug Y-cable according to aspects of the present disclosure.

FIG. 15 illustrates a flowchart of a method for transferring data between a host and a data storage device using a USB-C three-plug Y-cable, in accordance with aspects of the present disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Some aspects herein relate to portable data storage devices (DSD) having non-volatile memory (NVM), such as solid-state devices (SSDs), e.g., NAND flash memory storage devices (herein “NANDs”). (A NAND is a type of non-volatile storage technology that does not require power to retain data. It exploits negative-AND, i.e., NAND, logic.) To provide a concrete example, a portable SSD having one or more NVM NAND dies will be used below in the description of various embodiments. The SSD may be connected to a host via a flexible connection cable or may be configured as a thumb drive for directly mounting to a host such as a laptop computer or smart phone. It is understood that at least some aspects described herein may be applicable to other forms of SSDs as well. For example, at least some aspects described herein may be applicable to phase-change memory (PCM) arrays, magneto-resistive random access memory (MRAM) arrays, and resistive random access memory (ReRAM) arrays. Features may be implemented within a CMOS direct bonded (CBA) NAND chip or die (wherein CMOS refers to a complementary metal-oxide-semiconductor). Features may also be implemented within 3D XPoint memory cores, ferroelectric random-access memory (FeRAM) cores, and other types of memory cores. In some embodiments, one or more of the memory modules or portions thereof may be configured as other types of storage class memory (SCM).

Generally speaking, the memory modules may include any of a variety of Random Access Memory (RAM), dynamic RAM (DRAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

Additional aspects herein relate to SSDs configured for use with Universal Serial Bus (USB) Type-C (herein “USB-C”) cables and connectors or similar reversible connectors. Notably, USB-C refers to the configuration of cables and connectors (i.e., the connection plugs and sockets). USB-C is not communication protocol. The USB-C connectors have two-fold rotational symmetry enabling a USB-C plug to be inserted into a corresponding USB-C socket (or receptacle) in either of two orientations. That is, the plugs and sockets have a physically symmetric pinout. Electrically, however, USB-C connectors are not symmetric and the two ends of a USB-C cable are electrically different due to the cable wiring. From the user standpoint, USB-C cables often appear symmetric because software within the devices that the cables interconnect are configured to make the plugs, sockets, and cables behave as though symmetric.

Various communication protocols are compatible with USB-C cables, including USB4. Under the USB4 standard, devices must support a data communication bit rate of at least 20 gigabits (Gbit/s or Gbps) (e.g., 10 Gbps for each of two concurrent lanes) and may enable rates of 40 Gbit/s (USB4 version 1.0) and 80 Gbit/s (USB4 version 2.0). USB4 is currently only defined for the USB-C connector. The USB4 standard mandates backwards compatibility to USB 2.0 and USB 3.x. USB 3.2 (aka USB 10 Gbps) provides for 10 Gbps transmission rates. USB 2.0 provides for 480 Mbps. Note that, herein, the USB-C cables used in the various embodiments are “Full-Featured” Type C cables compatible with USB4 and USB 3.x. There are also USB 2.0 Type-C cables compatible with only USB 2.0. Some aspects of the disclosure are also be compatible with other (non-USB) reversible connectors, as discussed below.

TABLE I lists current USB standards (versions or protocols) and connectors:

TABLE I

| | | | Original USB | Current USB | USB |
|---|---|---|---|---|---|
| USB Version | Max. Speed | | Name | Name | Connectors |
| 1.1/1.0 | 12 | Mbps | — | — | Type-A, |
| | | | | | Type-B |
| 2.0 | 480 | Mbps | Hi-Speed USB | — | Type-A, |
| | | | | | Type-B, |
| | | | | | Type-C, |
| | | | | | Mini, Micro |
| 3.0 | 5 | Gbps | SuperSpeed | USB 5 Gbps | Type-A, |
| 3.1 Gen 1/ | | | USB | | Type-B, |
| 3.2 Gen 1 | | | | | Type-C, |
| | | | | | Micro |
| 3.1 Gen 2/ | 10 | Gbps | SuperSpeed | USB 10 Gbps | Type-A, |
| 3.2 Gen 2 | | | USB 10 Gbps | | Type-C |
| 3.2 Gen 2 × 2 | 20 | Gbps | SuperSpeed | USB 20 Gbps | Type-C |
| | | | USB 20 Gbps | | |
| USB4 | 20/40 | Gbps | — | USB 20 Gbps/ | Type-C |
| | | | | USB 40 Gbps | |
| USB4 Version 2 | 80 | Gbps | — | — | Type-C |

(USB 2.0)

### Overview

Data storage product capacities are often limited by memory technology limitations. In some SSD examples, using quad-level-cell (QLC) NAND technology, the maximum memory capacity of the SSD may be 8 Terabytes (TB). For example, the SSD may be configured with four NAND chips, each capable of storing 2 TB of data. The four 2 TB NAND chips are connected via four Flash Interface Module (FIM) channels to a single data storage controller, which may be configured as an application specific integrated circuit (ASIC).

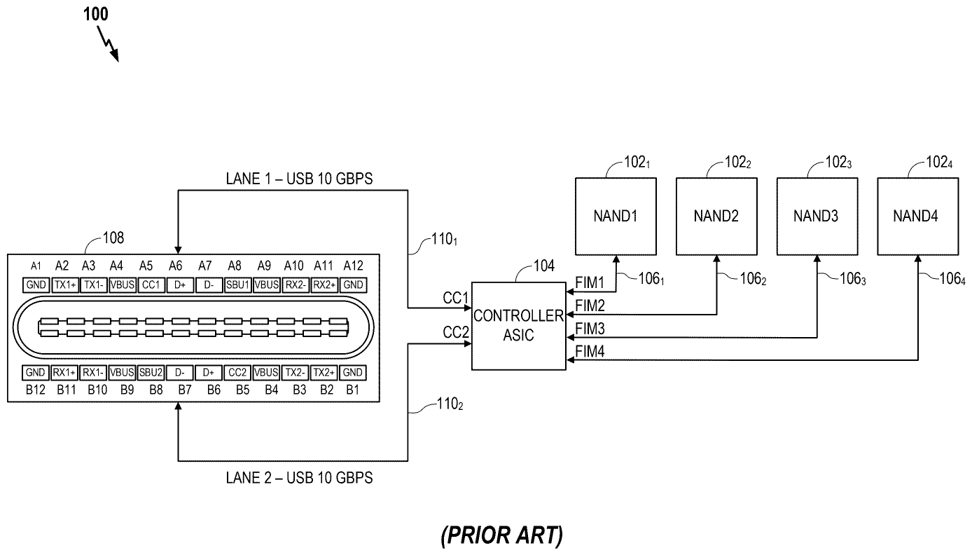

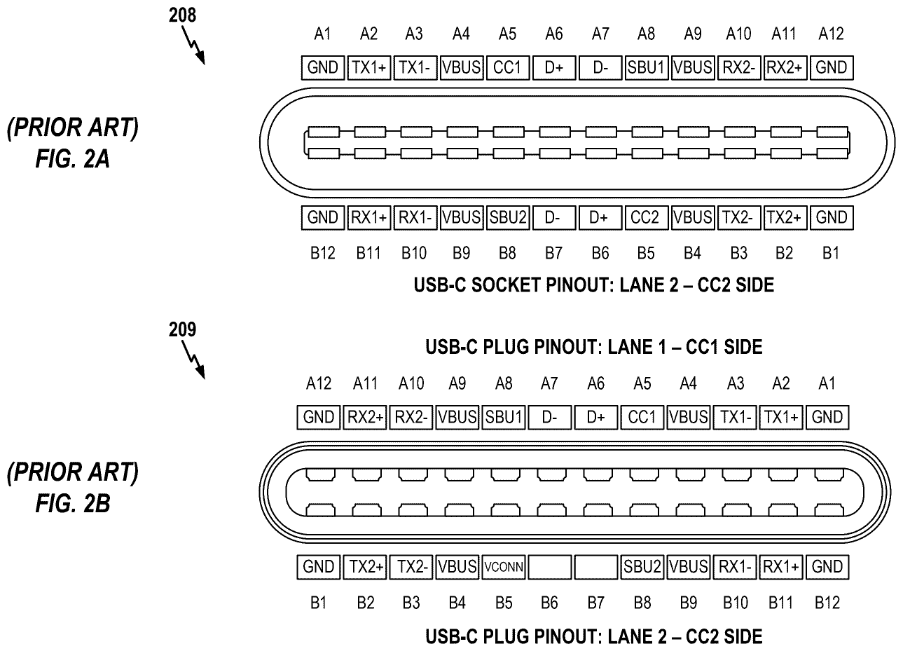

FIG. 1 illustrates a prior art example of an SSD 100 with four NAND chips 102₁-102₄ connected to a data storage controller 104 via four FIM channels 106₁-106₄. The SSD 100 also includes a USB-C connector socket (or receptable) 108 that accommodates two communication lanes. (See, also, FIG. 2 for an enlarged view of the USB-C connector socket pinout.) A first communication lane 110₁ is connected from the data storage controller 104 to a first row of pins of the USB-C connector socket 108. A second communication lane 110₂ is connected from the data storage controller 104 to a second row of pins in the USB-C connector socket 108. Although not shown in FIG. 1, the data storage controller 104 includes frontend components that implement a USB-C-compatible protocol (such as USB 10 Gbps) for use with the USB-C connector socket 108 and backend components that interface with the FIM channels that connect to individual NAND chips 102₁-102₄ of the SSD for storing (programming) data to the NAND chips and for reading (sensing) out data from the NAND chips. In other examples, the frontend components may be configured to operate at other rates, such as 12 Mbps, 480 Mbps, or 5 Gbps. 10 Gbps is thus just one example.

The data storage controller 104 of FIG. 1 is configured to provide a throughput of 10 Gbps from the NAND chips to an external host via the USB-C connector socket and a USB-C cable via either the first lane or the second lane, depending upon the orientation of the USB-C connector plug that is inserted into the USB-C connector socket. That is, the exemplary SSD 100 of FIG. 1 is not capable of 20 Gbps data transfer, even though the USB-C cable and the host may be capable of 20 Gbps data transfer (or even higher rates, such as 40 Gbps or 80 Gbps). The SSD 100 of FIG. 1 is capable of only 10 Gbps, either using lane 110₁ or lane 110₂, because its data storage controller and its FIM channels are only capable of a maximum of 10 Gbps (e.g., they are configured for use with USB 10 Gbps). To accommodate 20 Gbps, the SSD would require more expensive components that require more power and generate more heat, such as data storage controller ASICs configured for use with USB4 rather than USB 10 Gbps. Thus, SSD 100 of FIG. 1 is capable of either transferring data at 10 Gbps via lane 110₁ or transferring data at 10 Gbps via lane 110₂, but not both concurrently. The SSD 100 of FIG. 1 is also provided with only a total of four NAND chips providing 8 TB of memory.

FIG. 2 provides an enlarged view of a conventional USB-C connector socket 208, which is configured to receive a USB-C connector plug 209 of an external USB-C cable that may be connected into a host, such as a laptop computer of a user. The USB-C connector socket 208 has a physically symmetric pinout with two sets of signal pins, one on the top row and one on the bottom row, that are physically aligned with one another so the USB-C connector plug can be inserted into the USB-C connector socket 208 in either of two opposite mating orientations. As such, the USB-C connector plug is reversible and can be removed from the USB-C connector socket 208, its orientation flipped, then re-inserted into the USB-C connector socket 208 and it will again fit. However, the pinout of the USB-C connector socket 208 and the corresponding USB-C connector plug 209 are not electrically symmetric.

The electrical interface provided when the USB-C connector plug 209 is inserted in one orientation differs from the electrical interface provided when the USB-C connector plug 209 is inserted in the opposite orientation. Notably, one set of pins (e.g., the upper set) in the socket 208 has a configuration channel 1 (CC1) pin and the other set in the socket 208 (e.g., the lower set) has a CC2 pin. However, in the corresponding plug 209, the pinout includes only a single CC pin (CC1). There is no corresponding CC2 pin in the plug. As such, either the CC1 of the plug is connected to the CC1 of the socket (with the CC2 of the socket not connected to a corresponding CC pin) or the CC1 of the plug is connected to the CC2 of the socket (with the CC1 of the socket not connected to a corresponding CC pin). This enables the host and the SSD to detect the orientation of the USB-C connector plug to enable the correct lane for communication (i.e., lane 110₁ or 110₂ of FIG. 1). If CC1 of the plug is electrically connected to the CC1 of the socket, the first lane 110₁ is enabled and used for communication. If the USB-C connector plug is reversed, CC1 of the plug is electrically connected to CC2 of the socket and the second lane 110₂ is enabled and used for communication. (Note that the VCONN pin of the USB-C plug can also function as a configuration channel pin. Thus, if the SSD has a plug, rather than a socket, one of the lanes of the SSD can be connected to the CC1 of the plug while the other lane of the SSD can be connected to the VCONN pin. Thus, herein, the VCONN pin is also considered to be a configuration orientation pin.)

Thus, when using the SSD of FIG. 1, the user of the host can access the four NAND chips (for a total of 8 TB of memory) via either the first or second lanes (110₁ and 110₂). From the user's point of view, the orientation of the USB-C connector plug does not matter and so the plug can be inserted in either orientation. However, the SSD is provided with only 8 TB of total memory. It would be desirable to instead provide an SSD with 16 TB of memory, yet without requiring the provision of a more expensive and more power consuming (and more heat generating) data storage controller equipped to accommodate the 16 TB of memory. In the following, a solution to this problem is provided.

Briefly, an SSD is described herein that includes two (relatively inexpensive) data storage controller ASICs, each configured to accommodate a total memory space of 8 TB with a data transfer throughput of 10 Gbps. A first set of four 2 TB NAND chips is coupled to a first data storage controller, and a second set of four 2 TB NAND chips is coupled to a second data storage controller, for a total of 16 TB, thus doubling the capacity of the SSD of FIG. 1. One lane of the USB-C connector socket is connected to the first data storage controller and its corresponding NANDs. The second lane of the USB-C connector socket is connected to the second data storage controller and its corresponding NANDs. At any given time, depending upon the mating orientation of the plug in the socket, only one of the two CC pins (CC1 or CC2) of the socket is connected to the corresponding CC1 pin of the plug to enable either the first lane or the second lane to be active. Thus, only one of the two data storage controllers (along with its corresponding NAND chips) is accessible at 10 Gbps to the user via the host.

When the user connects the SSD in the first mating orientation, lane 1—which connects to the first data storage controller and its NANDs on “side 1” of the SSD—is enabled and accessed by the host, thus providing access to the user to a first 8 TB storage space on that “side” of the SSD. If the user flips the USB-C connection plug (or flips the SSD itself) and re-connects the SSD to the host, lane 2 is instead enabled and the user can access another storage space of 8 TB (via the second data storage controller). That is, a flip of the USB-C connector plug within the SSD's USB-C connector socket enables the user to switch the storage space to access two 8 TB capacities of the total 16 TB of available storage space. Note that the SSD may be connected to a host via a USB-C cable or the SSD may be configured as a thumb drive (or memory stick, pen drive, etc.) for directly attaching to a host. If a cable is used, the cable may be flipped and then re-inserted into the socket of the SSD. If the SSD is configured as a thumb drive, the thumb drive itself may be removed from the host, flipped, and then reattached.

Further, in some aspects the power circuitry in the SSD may be configured so that power is provided to only one of the two data storage controllers and its respective set of NANDs (based on the active lane). The other data storage controller and its respective NANDs remain powered off. That is, one data storage controller and its corresponding NANDs are kept powered off at any point of time, thus reducing power consumption and heat. In this manner, 16 TB of memory space is provided to the user without requiring the use of more expensive data storage controller ASICs and without consuming more power or generating more heat. Power disconnection is optional. In other examples, both data storage controllers and their respective NANDs remained powered-up.

In some examples, a portable SSD may be provided that can be easily flipped by the user to access a different “side” of the SSD (via reinsertion the USB-C connection plug in the opposite orientation) to mimic the manner by which one flips a record to listen to a different side of the record. The SSD may have, for example, different graphics on one side of the SSD compared to the other side surface, or may have different colors (e.g., red vs blue). This helps emphasize to the user that there are two separate memory spaces that are accessible. In one aspect, one side of the SSD may be used for personal data (e.g., videos, computer game data, etc.), while the other side may be used for work data (e.g., spreadsheets, etc.) In another aspect, one side may be used as the primary side and the other side may be used as a backup side.

Still other aspects of the disclosure relate to “Y-type” three-plug USB cables configured to enable a portable SSD of the type described herein to be connected to two USB sockets of a host to enable the host to concurrently access both “sides” of the SSD via two USB communication lanes. The three-plug cable described herein is primarily intended for use with SuperSpeed-compatible devices that operate in accordance with USB 5 or USB 10 Gbps and thus require only a single lane of operation. (USB 20 Gbps instead uses two communications lanes, with 10 Gbps on one lane and 10 Gbps on another lane). The three-plug cable connects the first communication lane within the cable (e.g., TX1/RX1 lines) between a single USB-C socket of the SSD and a first USB-C socket of the host to enable the host to access a first memory space of the SSD, e.g., 8 TB, via a first controller of the SSD. The cable also concurrently connects the second communication lane within the cable (e.g., TX2/RX2 lines) between the same USB-C socket of the SSD and a second, adjacent USB-C socket of the host to enable the host to concurrently access a second memory space of the SSD, e.g., 8 TB, via a second controller of the SSD. Within the OS of the host, the two memory spaces of the SSD appear as two separate drives or volumes (e.g., F; and G:). In this manner, the entire memory space of the SSD (e.g., 16 TB) is accessible by the host. No hub is needed. No changes to the OS of the host are needed. The host “sees” two different memory spaces as if two separate SSDs were connected to the host via two separate cables to its two separate USB sockets.

Although the primary example described herein uses Type-C plugs on the cable and Type-C sockets in the SSD and host, other variations are possible. For example, the host USB sockets can instead be Type-A sockets (9 pin or 4 pin) with corresponding Type-A plugs at the host-end of the cable. The SSD socket and the corresponding plug on the SSD-end of cable should be Type-C to enable concurrent access to both memory spaces of the SSD (with the pins of the Type-A plug on the host side properly connected to the appropriate corresponding pins of the Type-C plug on the device side). Note also that the three-plug cable enables the SSD to derive power from both of the USB ports of the host, e.g., 4.5 W from each port, for an overall budget of, e.g., 9 W. Power may be drawn from the two USB ports with or without power delivery negotiation, depending on the configuration. The cable may be a passive cable or an active cable that includes an E-Marker chip. These and other features will be described in detail in the following sections.

Still further, although described primarily with reference to data storage devices that are SSDs, the data storage device may instead be any form of data storage device or memory device, such as a hard-disk drive (HDD), hybrid SSD/HDD drive, USB drive (e.g., flash drive or thumb drive), etc. Moreover, although described primarily with reference to transferring data at SuperSpeed rates or higher, the cable can additionally or alternatively transfer data at slower rates such as 12 mega-bits-per-second (Mbps) or 480 Mbps.

Exemplary SSD with Two Separate Memory Spaces and Memory Controllers

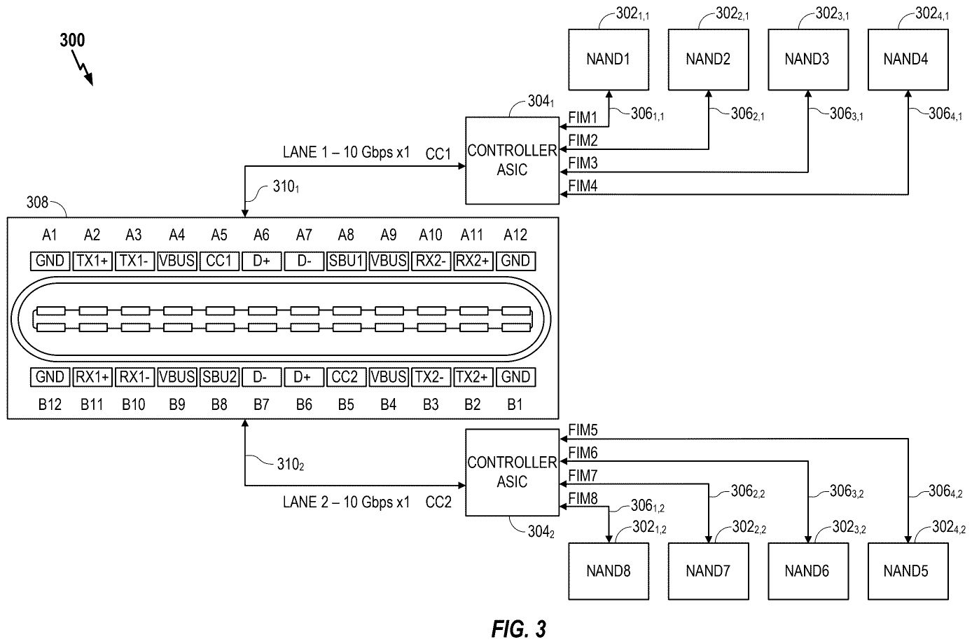

FIG. 3 illustrates an SSD 300 configured in accordance with aspects of the present disclosure wherein two data storage controllers are provided, each connected to four NAND chips, thus providing a total memory capacity of 16 TB. SSD 300 has a first set of four NAND chips 302_{1,1}-302_{4,1} connected to a first data storage controller 304₁ via four FIM channels 306_{1,1}-306_{4,1}. The SSD 300 also includes a USB-C connector socket (or receptable) 308 (see, again, FIG. 2) that accommodates two communication lanes. A first communication lane 310₁ is connected from the data storage controller 304₁ to a first row of pins of the USB-C connector socket 308. The second communication lane 310₂ is connected to a second data storage controller 304₂ via a second row of pins in the USB-C connector socket 308. The second data storage controller 304₂ is connected to a second set of four NAND chips 302_{1,2}-302_{4,2} via four FIM channels 306_{1,2}-306_{4,2}. Although not shown in FIG. 3, each of the two data storage controllers 304₁, 304₂ includes frontend components that implement a USB-C-compatible protocol (such as USB 10 Gbps) for use with the USB-C connector socket 308 and backend components that interface with the corresponding FIM channels that connect to the corresponding NAND chips of the SSD for storing (programming) data to the NAND chips and for reading out (sensing) data from the NAND chips.

The two data storage controllers 304₁, 304₂ of FIG. 3 are each configured to provide a throughput of 10 Gbps from the NAND chips to an external host via the USB-C connector socket and a USB-C cable via its corresponding lane. However, only one of the two data storage controllers 304₁, 304₂ is enabled at any given time based on the mating orientation of the USB-C connector plug (see, again, FIG. 2) in the USB-C connector socket 308. The CC pins (CC1 and CC2) of the USB-C connector socket 308 are used by the host and the SSD 300 to detect the orientation of the USB-C connector plug to enable a particular lane for communication (i.e., lane 310₁ or 310₂) to enable access to either NAND chips 302_{1,1}-302_{4,1} via data storage controller 304₁ or NAND chips 302_{1,1}-302_{4,1} via data storage controller 304₂. As noted above, when the USB-C plug is inserted, only one of the two CC pins in the USB-C socket is electrically connected to the host. If CC1 is electrically connected, then the first lanes 110₁ are enabled and NAND chips 302_{1,1}-302_{4,1} are accessible to the host. If the USB-C connector plug is reversed (flipped), then CC2 is electrically connected and the second lanes 110₂ are enabled and NAND chips 302_{1,2}-302_{4,2} are accessible to the host.

Notably, both data storage controller 304₁ and data storage controller 304₂ can be relatively inexpensive data storage controller ASICs configured to use with a maximum of four FIMs at a throughput of 10 Gbps. Moreover, whichever data storage controller is not being used (because the corresponding lane is not detected by the host) can be powered down, along with its corresponding set of NAND chips, to reduce power and reduce heat. If the USB-C connector plug is then reversed by the user, the opposite lane is enabled and so the data storage controller (and its NAND chips) that were powered-down are powered up, whereas the data storage controller (and its NAND chips) that had been active are powered down. In some examples, one set of NAND chips may be used by a user for personal data (e.g., videos, computer game data, etc.), while the other set of NAND chips may be used for work data (e.g., spreadsheets, etc.) In other examples, one set of NAND chips may be used by the user for primary data storage while the other set of NAND chips may be used for data backup.

As noted above, one set of NAND chips may be regarded as representing one “side” of the SSD, whereas the other set of NAND chips may be regarded as representing the other “side” of the SSD. To access a first side of the SSD, the USB-C plug is inserted into the USB-C socket in one orientation. To access the other side of the SSD, the USB-C plug may be removed, the SSD flipped up-side-down, and then the plug is reinserted into the USB-C socket. Alternatively, the USB-C plug is flipped, then reinserted.

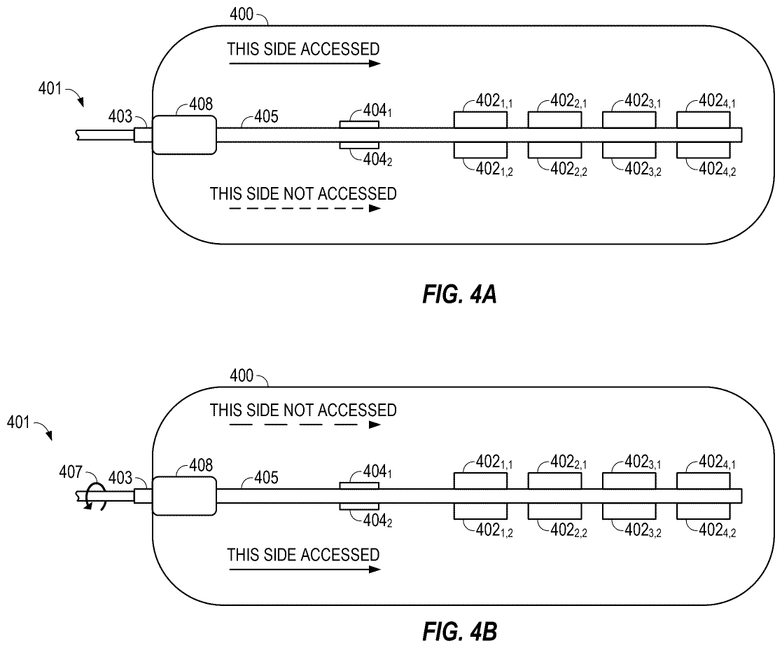

FIGS. 4A and 4B further illustrate how one “side” or the other of an SSD may be accessed either by flipping the USB-C cable plug and then reinserting the plug into the SSD or, equivalently, by flipping the SSD and then reinserting the USB-C cable plug into the SSD.

FIG. 4A illustrates an SSD 400 with a USB-C cable 401 having a USB-C cable plug 403 inserted into a USB-C cable socket 408. Although not shown in the figure, the opposite end of the USB-C cable 401 is connected into a host. In the orientation of FIG. 4A, a data storage controller 404₁ is enabled to provide access by the host to a first set of NAND chips 402_{1,1}-402_{4,1}. Data storage controller 404₂ is not enabled and so the host has no access to the second set of NAND chips 402_{1,2}-402_{4,2} representing the other “side” of the SSD. Note that the figure shows a central bar 405 that conceptually represents various connection lanes, busses and/or FIMs that interconnect the various components. Notably, as explained above, separate FIMs and connection lanes are provided for the two separate data storage controllers and their corresponding NAND chips. For clarity, the separate lanes, FIMS, etc., are omitted.

FIG. 4B illustrates the SSD 400 with the USB-C cable 401 flipped (as shown by arrow 407) with its USB-C cable plug 403 inserted into the USB-C cable socket 408 in the opposite orientation. In the configuration of FIG. 4B, a data storage controller 404₂ is enabled to provide access by the host to a second set of NAND chips 402_{1,2}-402_{4,2}. Data storage controller 404₁ is not enabled and so the host now has no access to the first set of NAND chips 402_{1,1}-402_{4,1}. Alternatively, the SSD itself may be flipped, with the USB-C cable plug reinserted so as to flip the orientation of the plug in the socket without flipping the plug.

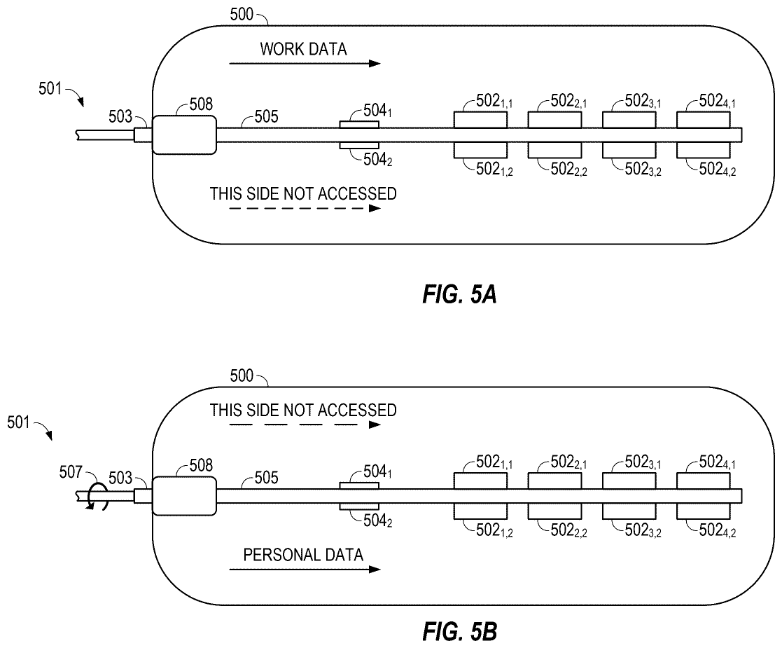

FIGS. 5A and 5B illustrate a use case in which one side of an SSD may be used by the user for storing work data (or “official” data), such as files, documents etc., whereas the other side of the SSD is used to store personal data, such as video game data, movies, etc. FIG. 5A illustrates an SSD 500 with a USB-C cable 501 having a USB-C cable plug 503 inserted into a USB-C cable socket 508. Although not shown in the figure, the opposite end of the USB-C cable 501 is connected into a host operator by a user. In the orientation of FIG. 5A, a data storage controller 504₁ is enabled to provide access by the user to a first set of NAND chips 502_{1,1}-502_{4,1} for storage of work data (or “official” data), such as files, documents etc. FIG. 5B illustrates the SSD 500 with the USB-C cable 501 flipped (as shown by arrow 507) with its USB-C cable plug 503 inserted into the USB-C cable socket 508 in the opposite orientation. In the configuration of FIG. 5B, a data storage controller 504₂ is enabled to provide access by the user to a second set of NAND chips 502_{1,2}-502_{4,2} for storage of personal data, such as video game data, movies, etc. Alternatively, the SSD may be flipped, with the USB-C cable plug reinserted to flip the orientation of the plug in the socket without flipping the plug. The figure shows a central bar 505 that conceptually represents various connection lanes, busses and/or FIMs that interconnect the various components. For clarity, the separate lanes, FIMS, etc., are omitted in FIGS. 5A and 5B.

Note also that the host devices described herein may be referred to as having a Downstream Facing Port (DFP), i.e. a USB port functioning as a host and power source. The SSDs described herein may be referred to as having an Upstream Facing Port (UFP), i.e., a USB port serving as a client and power sink. At least some aspects of the disclosure may also be applicable to a Dual Role Device (DRD), which is capable of functioning as either a host or client (and formerly referred to as an on-the-go (OTG) device). At least some aspects of the disclosure may also be applicable to Dual Role Power (DRP) devices, i.e., devices capable of operating as either a power provider or power consumer. Note also that the CC pins discussed above not only enable detection of cable orientation (mating orientation), the pins also enable identifying device roles to prevent damage and define communication hierarchy, and enable negotiating of power configurations between client and host devices for power distribution.

Co-pending U.S. patent application Ser. No. 18/954,986, entitled “DATA STORAGE DEVICE WITH DUAL MEMORY SPACES ACCESSIBLE BY A HOST USING DIFFERENT COMMUNICATION PROTOCOLS BASED ON THE MATING ORIENTATION OF REVERSIBLE CONNECTOR,” (Atty. Docket No. WDT-1463 (WDA-7797-US))), and assigned to the assignee of the present application, is fully incorporated by reference herein for all purposes, and it should be understood that various features and inventions of the present application and the co-pending application can be practiced together. By way of example and not limitation, an SSD may be provided that is configured to either (a) fully disconnect one of its data storage controllers and connection lanes depending upon the mating orientation of the USB-C plug as described herein or (b) enable concurrent operation of both data storage controllers and connection lanes to permit, e.g., USB 10 Gbps protocol data transfers via one of the connection lanes and simultaneous 480 Mbps USB 2.0 protocol transfers via the other of the connection lanes as described in the co-pending application.

### Additional Exemplary SSDs Embodiments

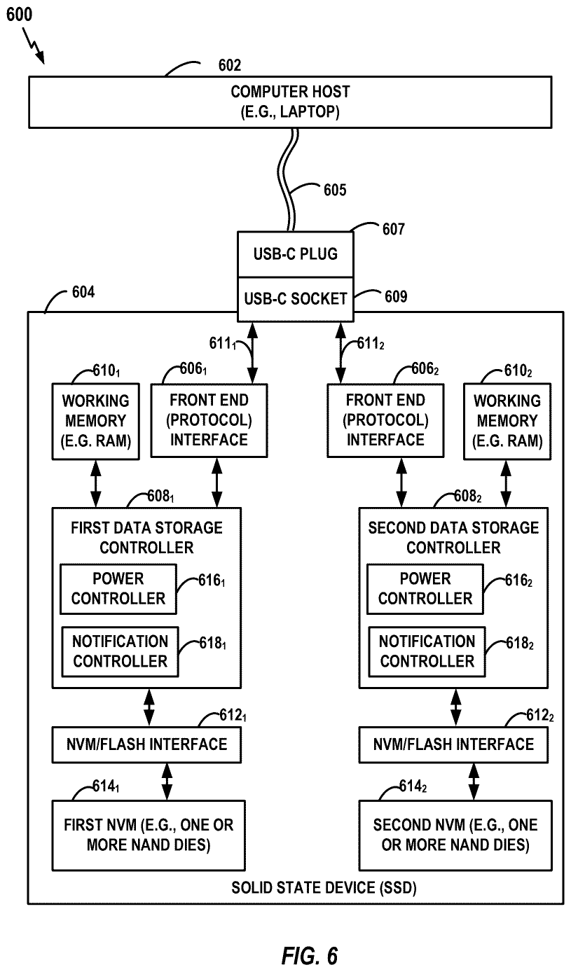

FIG. 6 is a block diagram of a system 600 including an exemplary computer host 602 (e.g., a laptop) and a solid state device (SSD) 604 configured with two data storage controllers and two NVM arrays. The host 602 is connected to the SSD 604 using an external USB-C connection cable 605 having a USB connection plug 607 for insertion into a USB-C connection socket 609 of the SSD in one of two mating orientations (as explained above).

The SSD 604 is configured to provide access to either the first or the second NVM array by the computer 602 depending upon the mating orientation. For example, in a first mating orientation, in which a first data storage controller 608₁ and a first NVM array 614₁ are communicatively coupled to the host 602, the host 602 may provide a write command to the SSD 604 for writing user data to NVM 614₁ or a read command for reading user data from the NVM 614₁, with access by the host 602 to the NVM 614₁ under the control of data storage controller 608₁. The SSD 604 includes a front end (protocol) interface 606₁ for interfacing with host 602 via the USB-C-compatible protocol (such as USB 10 Gbps) using a first connection lane 611₁. The SSD 604 also includes a working memory 610₁ (such as random access memory (RAM)), an NVM interface 612₁ (which may be referred to as a flash interface or backend interface), and the NVM 614₁, such as one or more NVM NAND dies or NVM arrays.

The data storage controller 608₁ includes a power controller 616₁ and a notification controller 618₁. The power controller 616₁ provides power to the data storage controller 608₁ and the first NVM 614₁ (and other components such as working memory 610₁) while the USB plug 607 and USB socket 609 are in the first mating configuration, but disconnects power while the USB plug 607 and USB socket 609 are in the second mating configuration. The notification controller 618₁ notifies the host 602 of the NVM 614₁ that is accessible while the USB plug 607 and USB socket 609 are in the first mating configuration. The notification controller 618₁ also notifies the host 602 that a second NVM 614₂ is present in the SSD 604 and can be accessed if the user flips the USB plug 607 and USB socket 609 to the second mating configuration. The host 602 can then notify the user of that option via an appropriate display screen indication.

In the second mating orientation, in which a second data storage controller 608₂ and the second NVM array 614₂ are communicatively coupled to the host 602, the host 602 may provide a write command for writing user data to NVM 614₂ or a read command for reading user data from the NVM 614₂, with access by the host 602 to the NVM 614₂ under the control of data storage controller 608₂. The SSD 604 includes a front end (protocol) interface 606₂ for interfacing with host 602 via the USB-C-compatible protocol (such as USB 10 Gbps) using a second connection lane 611₂. The SSD 604 also includes a working memory 610₂ (such as RAM), an NVM interface 612₂ (e.g., flash interface or backend interface), and the NVM 614₂, such as one or more NVM NAND dies or NVM arrays. The data storage controller 608₂ also includes a power controller 616₂ and a notification controller 618₂. The power controller 616₂ provides power to data storage controller 608₂ and NVM 614₂ (and other components such as working memory 610₂) while the USB plug 607 and USB socket 609 are in the second mating configuration, but disconnects power while the USB plug 607 and USB socket 609 are in the first mating configuration. The notification controller 618₂ notifies the host 602 of the NVM 614₂ that is accessible while the USB plug 607 and USB socket 609 are in the second mating configuration. The notification controller 618₂ also notifies the host 602 that NVM 614₂ is present in the SSD 604 and can be accessed if the user flips the USB plug 607 and USB socket 609 to the first mating configuration so the host 602 can notify the user of that option.

Note that although the power controllers and notification controllers are shown as components of the data storage controllers, they may be implemented as separate components. Moreover, rather than having separate power controllers and notification controllers, as shown, a single power controller and/or single notification controller can instead be provided, i.e., as components that are separate from the data storage controllers. Furthermore, the provision and function of the power controllers may depend on the source of power for the SSD. For example, if the only source of power is from the host via the external cable and the connection lanes, then power to the data storage controller that is currently receiving power (and its set of NAND chips) may be disconnected by the host when the external cable plug is removed from the socket, with power then applied to the other data storage controller (and its set of NAND chips) when the plug is reinserted in the opposite mating orientation. If the SSD has its own internal power source, e.g., a battery, then the power controllers within the SSD may be configured to control power delivery based on the mating orientation of the plug.

In the primary examples herein, the host 602 is a laptop computer. However, host 602 may be any system or device needing data storage or retrieval and a compatible interface for communicating with the SSD 604. For example, the host 602 may be a computing device, a desktop computer, a personal computer, a portable computer, a workstation, a server, a personal digital assistant, a digital camera, an Internet of Things (IoT) device, or a mobile phone. Still further, in some examples, the host may be any other device accessible via USB-C or a similar communication interface having a reversible connection scheme.

In the primary examples described herein, the cable 605 provides a USB-C interface. However, in other examples, other suitable communication interfaces may be used, if configured with reversible connectors that can be physically coupled in one of two mating configurations, e.g., the connectors have a physically symmetric but electrically asymmetric pinout to thereby permit the mating orientation to be detected from the electrical asymmetry. For example, the Thunderbolt 4 interface is reversible. Aspects described herein may also be applicable to the Peripheral Component Interconnect Express (PCIe) interface. Future versions of USB interfaces are also expected to be reversible.

Note that the data storage controllers 608₁ and 608₂ of FIG. 6 may include any type of processing device, such as a microprocessor, a microcontroller, an embedded controller, a logic circuit, software, firmware, or the like, for controlling the operation of the SSD 604. In some aspects, some or all of the functions described herein as performed by one or both of the data storage controllers may instead be performed by another element of the SSD 604. For example, the SSD 604 may include a microprocessor, a microcontroller, an embedded controller, a logic circuit, software, firmware, or any kind of processing device, for performing one or more of the functions described herein as being performed by one or both of the data storage controllers.

The working memories 610₁ and 610₂ of FIG. 6 may be any suitable memory or system capable of storing data. For example, the memories may be ordinary RAM, DRAM, double data rate (DDR) RAM (DRAM), static RAM (SRAM), synchronous dynamic RAM (SDRAM), flash storage, an erasable programmable read-only-memory (EPROM), an electrically erasable programmable ROM (EEPROM), or the like. In various embodiments, the data storage controllers use the working memories, or portions thereof, to store data during the transfer (transference) of data between the host 602 and the NVMs. For example, the working memories or portions thereof may be a cache memory. The NVMs 614₁ and 614₂ may be any suitable type of non-volatile memory, such as a NAND-type flash memory or the like.

Although FIG. 6 shows an exemplary SSD that is configured as an SSD with flash NAND NVM, the various disclosed embodiments are not necessarily limited to an SSD application/implementation. The disclosed NVM dies and associated processing components can be implemented as part of a package that includes other processing circuitry and/or components. For example, a processor may include, or otherwise be coupled with, embedded NVM and associated circuitry and/or components. The processor could, as one example, offload certain tasks to the NVM and associated circuitry and/or components. Still further, the data storage device 604 may have volatile memory such as DRAM chips instead of NAND dies as its primary memory. That is, NVM 614₁ may instead be a first DRAM and NVM 614₂ may instead be a second DRAM. In such an implementation, the interfaces 612₁ and 612₂ would not be flash interfaces but double/dual data rate (DDR) interfaces for use with the DRAMs.

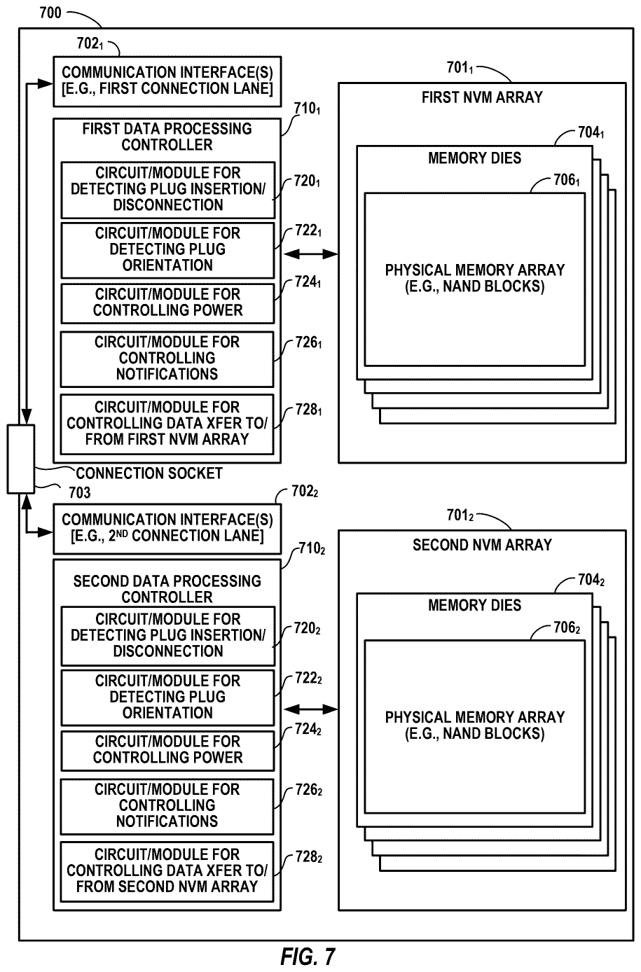

FIG. 7 illustrates an embodiment of an apparatus 700 configured according to one or more aspects of the disclosure. The apparatus 700, or components thereof, could embody or be implemented as a data storage controller within a portable SSD, or other type of device that supports computations and data storage.

The apparatus 700 has a first set of components denoted by subscript 1 and a second set of components denoted by subscript 2, which are operative depending upon a plug orientation within a connection socket 703, which may be a USB-C connection socket. (In FIG. 7, the plug is not shown, but see, e.g., FIG. 6.) A first data processing controller 710₁ is communicatively coupled to a first NVM die array 701₁ that includes one or more memory dies 704₁, each of which may include physical memory arrays 706₁, e.g., NAND blocks. The data processing controller 710₁ may include various modules/circuits, including firmware (FW) components. These components can be coupled to and/or placed in electrical communication with one another and with the NVM die array 701₁ via suitable components, represented generally by connection lines in FIG. 7. Although not shown, other circuits such as timing sources, peripherals, voltage regulators, and power management circuits may be provided, which are well known in the art, and therefore, will not be described any further.

In some examples, the memory dies may include on-chip circuitry such as under-the-array circuitry. The memory dies 704₁ may be communicatively coupled to the data processing controller 710₁ such that the apparatus 700 can read or sense information from, and write or program information to, the physical memory array 706₁. That is, the physical memory array 706₁ can be coupled to controller 710₁ so that the physical memory array 706₁ is accessible by the controller 710₁. The dies may additionally include, e.g., input/output components, registers, voltage regulators, etc. The connection between the controller 710₁ and the memory dies 704₁ of the NVM die array 701₁ may include, for example, one or more busses.

The apparatus 700 includes a first communication interface 702₁, e.g. a first communication lane, for connecting via socket 703 to a laptop, a mobile phone, etc. using, e.g., USB-C-compatible protocols (such as USB 10 Gbps or USB4) other suitable communication protocols. More generally, the communication interface 702₁ provides a means for communicating with other apparatuses over a transmission medium. In some implementations, the communication interface 702₁ includes circuitry and/or programming (e.g., a program) adapted to facilitate the communication of information bi-directionally with respect to one or more devices in a system. In some implementations, the communication interface 702₁ may be configured for wire-based communication. For example, the communication interface 702₁ could be a send/receive interface or some other type of signal interface including circuitry for outputting and/or obtaining signals (e.g., signals to/from a host). The communication interface 702₁ serves as one example of a means for receiving and/or a means for transmitting.

The modules/circuits of the data storage controller 710₁ are arranged or configured to obtain, process, and/or send data, control data access and storage, issue or respond to commands, and control other desired operations. For example, the controller 710₁ may be implemented as one or more processors, one or more controllers, and/or other structures configured to perform functions. According to one or more aspects of the disclosure, the controller 710₁ may be adapted to perform any or all of the features, processes, functions, operations, and/or routines described herein as being performed by the data storage controller. For example, the controller 710₁ may be configured to perform any of the data storage controller steps, functions, and/or processes described with respect to FIGS. 3-6 and FIGS. 8-9, discussed below.

As used herein, the term “adapted” in relation to the data processing controller 710₁ may refer to the modules/circuits being one or more of configured, employed, implemented, and/or programmed to perform a particular process, function, operation and/or routine according to various features described herein. The modules/circuits may include a specialized processor, such as an application-specific integrated circuit (ASIC) that serves as a means for (e.g., structure for) carrying out any one of the data storage controller operations described in conjunction with, e.g., FIGS. 3-6 and 8-9. The modules/circuits serve as an example of a means for processing. In various implementations, the modules/circuits may provide and/or incorporate, at least in part, functionality described above for the components in various embodiments shown, including for example data storage controller 608₁ of FIG. 6.

According to at least one example of the apparatus 700, the data processing controller 710₁ may include one or more of: a circuit/module 720₁ for detecting plug insertion/disconnection via communication interface 702₁ (see, again, the USB-C plugs/sockets discussed above and the electrical asymmetry of the CC1 and CC2 pins); a circuit/module 722₁ for detecting plug orientation (by detecting, e.g., a CC1 connection instead of a CC2 connection) and, in response, for enabling access by a host via an external cable to the first NVM array 701₁; a circuit/module 724₁ for controlling power (e.g., to provide power to the NVM array 701₁ if CC1 is active but not otherwise); a circuit/module 726₁ for controlling notifications sent to the host (e.g., to notify the host of the presence or availability within the SSD 700 of the other NVM array 701₂ even if the other NVM array is not currently accessible to the host); and a circuit/module 728₁ for controlling data transfer between the host and the first NVM array 701₁.

In at least some examples, means may be provided for performing the functions illustrated in FIG. 7 and/or other functions illustrated or described herein. For example, the means may include one or more of: means, such as circuit/module 720₁, for detecting plug insertion/disconnection via communication interface 702₁; means, such a circuit/module 722₁, for detecting plug orientation; means, such a circuit/module 724₁, for controlling power; means, such a circuit/module 726₁, for controlling notifications sent to the host; and means, such a circuit/module 728₁, for controlling data transfer between the host and the first NVM array 701₁. In yet another aspect of the disclosure, a non-transitory computer-readable medium is provided that has one or more instructions which when executed by a processing circuit in an SSD causes the data storage controller of the SSD to perform one or more of the functions or operations listed above.

As noted, a second set of components are provided, which may be configured the same as the first set of components but configured to operate if the USB plug is in the opposite mating configuration (as explained above). The second set of components will only briefly be described. A data processing controller 710₂ is communicatively coupled to a second NVM die array 701₂ that includes one or more memory dies 704₂, each of which may include physical memory arrays 706₂, e.g., NAND blocks. The apparatus 700 includes a second communication interface 702₂, e.g. a second communication lane, connected to the socket 703.

According to at least one example of the apparatus 700, the processing controller 710₂ may include one or more of: a circuit/module 720₁ for detecting plug insertion/disconnection via communication interface 702₂; a circuit/module 722₂ for detecting plug orientation (by detecting, e.g., a CC2 connection rather than the CC1 connection) and, in response, for enabling access by the host to the second NVM array 701₂; a circuit/module 724₂ for controlling power (e.g., to provide power to the NVM array 701₂ if CC2 is active but not otherwise); a circuit/module 726₂ for controlling notifications sent to the host (e.g., to notify the host of the presence or availability within the SSD 700 of the other NVM array 701₁ even if the other NVM array is not currently accessible to the host); and a circuit/module 728₂ for controlling data transfer between the host and the second NVM array 701₂. Corresponding means may be provided for performing equivalent functions.

Still further, note that: circuit/module 722₁ provides a means for detecting a connection of the second connector in a first mating orientation with the first connector and, in response, for enabling access by the host via the external cable to the first NVM array under the control of the first data storage controller; circuit/module 720₁ provides a means for detecting a disconnection of the second connector from the first connector and, in response, for disabling access by the host to the first NVM array; and circuit/module 722₂ provides a means for detecting a connection of the second connector in a second, different mating orientation with the first connector and, in response, for enabling access by the host via the external cable to the second NVM array under the control of the second data storage controller.

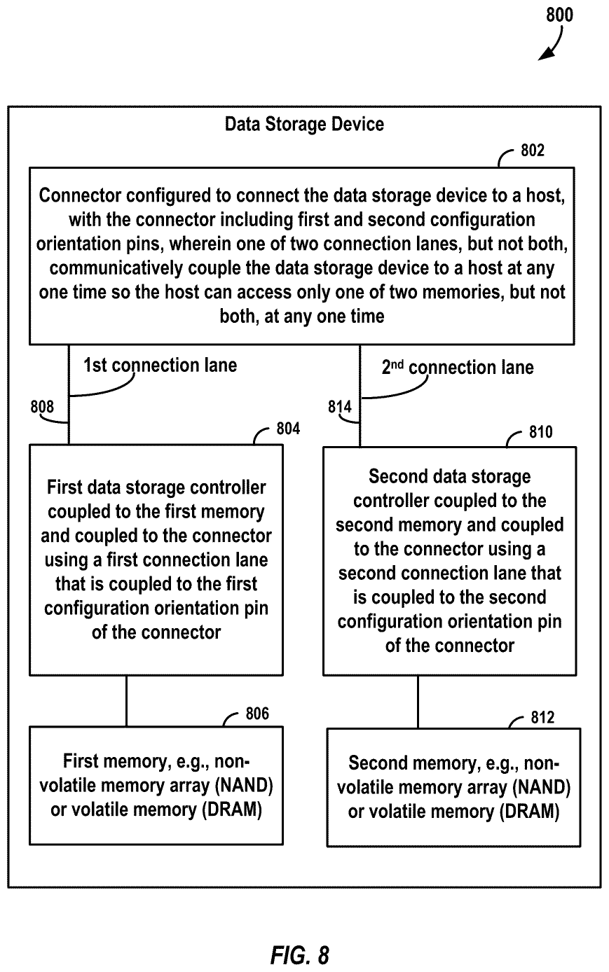

FIG. 8 is a block diagram of an exemplary data storage device 800 in accordance with some aspects of the disclosure. The data storage device 800 includes: a (first) connector 802 (such as a USB-C socket) configured to connect the data storage device to a host via an external (second) connector (such as a USB-C cable with a USB-C plug), with the connector 802 including first and second configuration orientation pins (e.g., CC1 and CC2). The data storage device 800 also includes: a first data storage controller 804 coupled to a first memory 806 (which may be an NVM such as a NAND or a volatile memory such as a DRAM) and coupled to the connector 802 using a first connection lane 808 that is coupled to the first configuration orientation pin (e.g., CC1) of the connector 802. The data storage device 800 also includes: a second data storage controller 810 coupled to a second memory 812 (which also may be an NVM such as a NAND or a volatile memory such as a DRAM) and coupled to the connector 802 using a second connection lane 814 that is coupled to the second configuration orientation pin (e.g., CC2) of the connector 802. Only one of the two connection lanes (808, 814), but not both, communicatively couple the data storage device to a host via the connector 802 at any one time so the host can access only one of the two memories (806, 812), but not both, at any one time. The other data storage device and NVM array may be optionally powered-down when not accessible by the host.

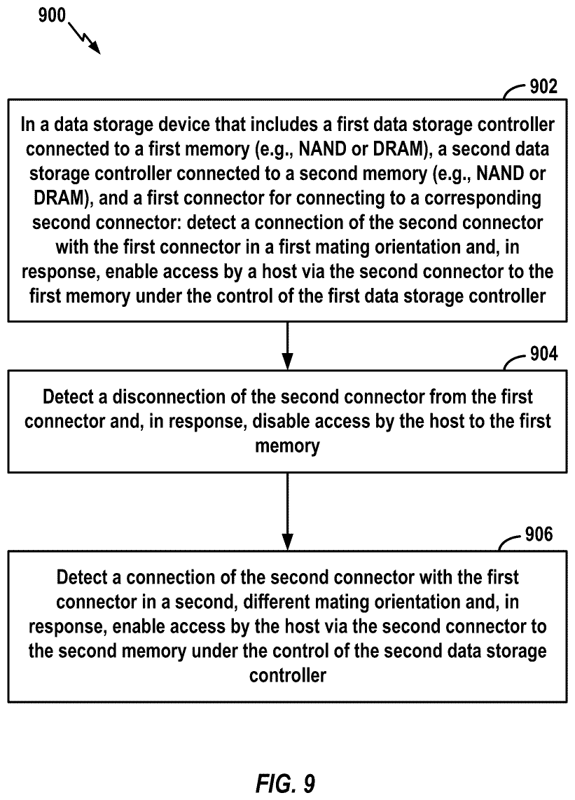

FIG. 9 illustrates a method or process 900 in accordance with some aspects of the disclosure for use by a data storage device that includes a first data storage controller connected to a first memory (e.g., NAND or a DRAM), a second data storage controller connected to a second memory (e.g., NAND or a DRAM), and a first connector for connecting to a corresponding second connector for coupling to a host. At block 902, the data storage device detects a connection of the second connector with the first connector in a first mating orientation and, in response, enables access by the host to the first memory under the control of the first data storage controller. At block 904, the data storage device detects a disconnection of the second connector from the first connector and, in response, disables access by the host to the first memory. At block 906, the data storage device detects a connection of the second connector with the first connector in a second, different mating orientation and, in response, enables access by the host to the second memory under the control of the second data storage controller.

In another aspects, a method or process is provided in accordance with some aspects of the disclosure for use by a data storage device that includes a first data storage controller connected to a first memory (e.g., NAND or DRAM), a second data storage controller connected to a second memory (e.g., NAND or DRAM). The method includes detecting a first connected configuration between the data storage device and an external connector (which may be at one end of an external cable) coupled (at its other end) to a host with the data storage device and the external connector in a first mating orientation and, in response, enabling access by the host to the first memory under the control of the first data storage controller. The method also includes detecting a disconnected configuration between the external connector and the data storage device and, in response, disabling access by the host to the first memory. The method further includes detecting a second connected configuration between the data storage device and the external connector in a second, different mating orientation and, in response, enabling access by the host to the second memory under the control of the second data storage controller.

### Three-Plug Cable Embodiments

In this section, a USB Type-C (USB-C) cable is configured as a three-plug Y-cable. As explained above in the Overview, the Y-cable is configured to enable a portable SSD of the type described above to be connected to two USB sockets (receptacles) of a host to enable the host to concurrently access both “sides” of the SSD via two USB communication lanes. The three-plug cable is primarily intended for use with SuperSpeed-compatible devices that operate in accordance with USB 5 Gbps or USB 10 Gbps and thus require only a single lane of operation. The three-plug cable connects the first physical communication lane within the cable (e.g., TX1/RX1 lines) between a single USB-C socket of the SSD and a first USB-C socket of the host to enable the host to access a first memory space of the SSD, e.g., 8 TB, via a first controller of the SSD. The cable also concurrently connects the second physical communication lane within the cable (e.g., TX2/RX2 lines) between the same USB-C socket of the SSD and a second, adjacent USB-C socket of the host to enable the host to concurrently access a second memory space of the SSD, e.g., 8 TB, via a second controller of the SSD.

Within the operating system (OS) of the host, the two memory spaces of the SSD appear as two separate drives or volumes (e.g., F: and G:). In this manner, the entire memory space of the SSD (e.g., 16 TB) is accessible by the host. No hub is needed. No changes to the OS of the host are needed. The host “sees” two different memory spaces as if two separate SSDs were connected to the host via separate USB cables to its separate USB sockets.

Note that the first communication lane of the Y-cable cable comprises a set of twelve physical connection lines (wires) within the cable that provide, among other lines, the TX1/RX1 lines. The second communication lane of the cable comprises a set of twelve physical connection lines (wires) within the cable that provide, among other lines, the TX2/RX2 lines. That is, these lanes are physical communication lanes. It should be understood that the host may define logical communication lanes, which might differ from the physical lanes.

Before describing the Y-cable, a brief summary of USB 5 or USB 10 Gbps protocol is provided as it applies to a conventional USB-C cable that has one plug at each end. When operating in accordance with USB 5 Gbps or USB 10 Gbps protocols, the host will use CC detection logic to determine the orientation of the plug. If the plug is inserted into the host socket so that the CC pin of a plug is connected to the CC1 pin of the host socket, the host will use the first physical communication lane (e.g., TX1/RX1 line) of the USB cable for data transfer at 5 or 10 Gbps to an external device by sending and receiving data through the host's TX1/RX1 pins. If the plug is inserted in the opposite orientation so that the CC pin of a plug is instead connected to the CC2 pin of the host socket, the host will again use the first physical communication lane (e.g., TX1/RX1 line) of the cable for data transfer. In this case, however, the host sends and receives data through the host's TX2/RX2 pins (which are connected to the TX1/RX1 pins of the plug in this orientation). Hence, for USB 5 Gbps or USB 10 Gbps, only one of the two physical communication lanes of the cable is used (i.e., communication lane #1). (The second physical communication lane is provided for USB 20 Gbps or above.) This feature is exploited herein to enable the Y-cable design with its two host-side plugs.

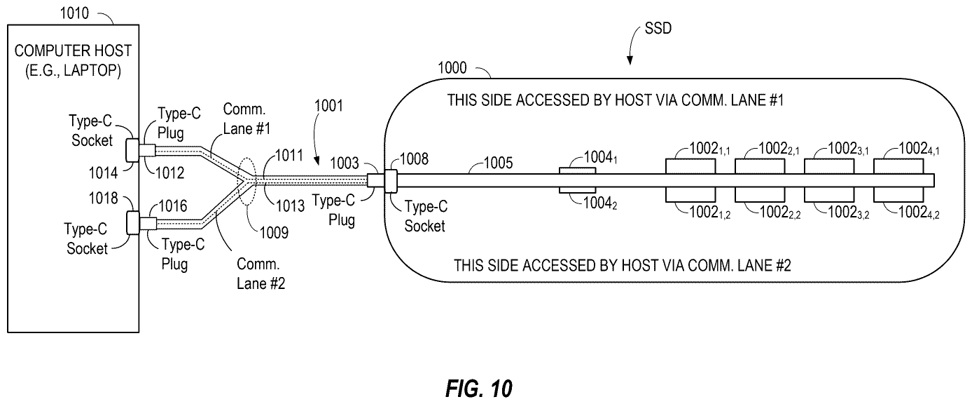

FIG. 10 illustrates an SSD 1000 with a USB Type-C (USB-C) three-plug Y-cable 1001 having a USB-C cable plug 1003 inserted into a USB-C cable socket 1008 of the SSD. The SSD includes a first data storage controller 1004₁ to provide access by a host 1010 to a first set of NAND chips 1002_{1,1}-1002_{4,1} and a second data storage controller 1004₂ to provide access by the host to a second set of NAND chips 1002_{1,2}-1002_{4,2}. Note that the figure shows a central bar 1005 in the SSD 1000 that represents various connection lanes, busses and/or FIMs that interconnect the various components of the SSD. As explained above, separate FIMs and connection lanes are provided for the two separate data storage controllers and their corresponding NAND chips. For clarity, the separate lanes, FIMS, etc., are omitted in FIG. 10.

As shown, the Y-cable 1001 splits at 1009 to provide: a first end with a first host-side USB-C cable plug 1012 for connecting into a first USB-C socket 1014 of the host 1010, and a second end with a second host-side USB-C cable plug 1016 for connecting into a second USB-C socket 1018 of the host 1010. Communication lane #1 (1011), which includes twelve lines/wires, not separately shown, is connected between SSD-side plug 1003 and host-side plug 1012. Communication lane #2 (1013), which also includes twelve lines/wires, not separately shown, is connected between SSD-side plug 1003 and host-side plug 1016. In use, the host accesses NAND chips 1002_{1,1}-1002_{4,1} via USB socket 1014, the first communication lane 1011, and the first data storage controller 1004₁ using USB 5 Gbps or USB 10 Gbps. Concurrently, the host accesses NAND chips 1002_{1,2}-1002_{4,2} via USB socket 1018, the second communication lane 1013, and the second data storage controller 1004₂ using USB 5 Gbps or USB 10 Gbps. The OS of the host “sees” the two memory spaces of the SSD as two separate drives and can display them to the user as separate drives or volumes (e.g., drive F: and G:). If the host and SSD are configured for USB 5 Gbps, then 5 Gbps can be used for each of the first and second lanes, providing a total of 10 Gbps of throughput to the SSD. If the host and SSD are configured for USB 10 Gbps, then 10 Gbps can be used for each of the first and second lanes, providing a total of 20 Gbps of throughput to the SSD. However, in some cases, the host might use 5 Gbps along the first communication lane and 10 Gbps along the second communication lane, or vice versa. The SSD may draw power along both the first and second communication lanes, e.g., 4.5 W from each host USB port, for an overall budget of, e.g., 9 W.

In some aspects, plug 1012 provides a means for receiving first data signals from a first connection socket of the host. Plug 1016 provides a means for receiving second data signals from a second connection socket of the host. Communication lane 1011 provides a means for transferring the first data signals along the connection cable at 5 Gbps or higher in accordance with a USB protocol. Communication lane 1013 provides a means for transferring the second data signals along the connection cable at 5 Gbps or higher in accordance with the USB protocol. Plug 1003 provides a means for transferring the first and second data signals into a connection socket of the data storage device.

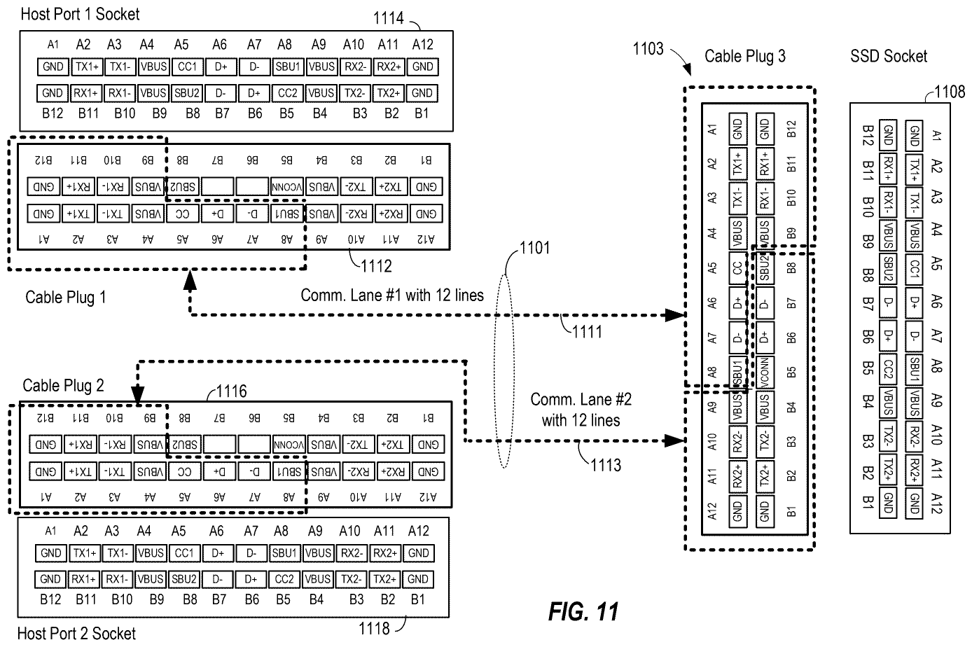

FIG. 11 illustrates the manner by which the Communication Lane #1 and Communication Lane #2 lines of the cable are routed between the pins of the plug inserted into the SSD and the corresponding pins in the two host-side plugs. The three-plug Y-cable 1101 has a USB-C cable plug 1103 inserted into a USB-C cable socket 1108 of the SSD. The Y-cable 1101 also has a first host-side USB-C cable plug 1112 for connecting into a first USB-C socket 1114 of the host and a second host-side USB-C cable plug 1116 for connecting into a second USB-C socket 1118 of the host. Communication lane #1 (1111), consisting of twelve lines/wires, not separately shown, is connected between the Communication Lane #1 pins of the SSD-side plug 1103 and the Communication Lane #1 pins of the host-side plug 1114. Communication lane #2 (1013), also consisting of twelve lines/wires, not separately shown, is connected between the communication lane #2 pins of the SSD-side plug 1103 and the communication lane #1 pins of host-side plug 1116. (In a standard USB-C cable with one plug at each end, the communication lane #2 lines connect the communication lane #2 pins of the SSD-side plug and the communication lane #2 pins of the single host-side plug.)

Note that the twelve lines/wires of communication lane #2 1113 are not connected to plug 1112, and the twelve lines/wires of communication lane #1 1111 are not connected to plug 1116. That is, although both plugs 1112 and 1116 have the full complement of twenty-four pins for physically mating with the corresponding twenty-four pins in the host sockets, half of the pins in plug 1112 are not connected to internal cable lines, and half of the pins in plug 1116 are not connected to internal cable lines. More specifically, within host side plug 1112, pins B1-B8 and A9-A12 are not connected via lines to corresponding pins in device side plug 1103. Pins A1-A8 and B9-B12 of plug 1112 are connected to the corresponding pins (A1-A8 and B9-B12) in device side plug 1103. Within host side plug 1116, pins B1-B8 and A9-A12 are also not connected via lines to corresponding pins in device side plug 1103. Pins A1-A8 and B9-B12 of plug 1116 are connected to the pins (B1-B8 and A9-A12) in device side plug 1103. Note also that the cable may also include an eMarker, not shown.

Although not shown in FIG. 11, the corresponding communication lane #1 pins of SSD socket 1108 are connected to the first data storage controller of the SSD (1004₁ of FIG. 10), and the corresponding pins communication lane #2 pins of SSD socket 1108 are connected to the second data storage controller of the SSD (1004₁ of FIG. 10). In this manner, the first data storage controller of the SSD (1004₁ of FIG. 10) can communicate with the host along the communication lane #1 of the cable (but not communication lane #2 of the cable) and the second data storage controller of the SSD (1004₂ of FIG. 10) can communicate with the host along the communication lane #2 of the cable (but not communication lane #1 of the cable).

Both plugs 1112 and 1116 are reversible plugs in accordance with the USB Type-C specification. Plug 1111 can be connected to host socket 1114 with plug 1116 connected to host socket 1118. Alternatively, plug 1111 could instead be connected to host socket 1118 with plug 1116 connected to host socket 1114. In other cases, only one of the plugs is connected to the host. That is, both plugs do not need to be connected at the same time to the host. If only plug 1111 is connected to the host, then only communication lane #1 may be used. If only plug 1116 is connected to the host, then only communication lane #2 may be used.

A first configuration will now be described in which plug 1111 is connected to host socket 1114 with plug 1116 connected to host socket 1118. If the plug 1111 is inserted into socket 1114 with CC of the plug connected to CC1 of that host socket, the host will detect that orientation and route signals from socket 1114 onto communication lane #1 of the cable 1101, which will be received by the SSD via its communication lane #1 pins for routing to its first memory space (NAND chips 1002_{1,1}-1002_{4,1}) via the first data storage controller 1004₁. If the plug 1111 is inserted into socket 1114 with CC of the plug connected to CC2 of that host socket, the host will detect that reverse orientation and again route signals from socket 1114 onto communication lane #1 of the cable 1101, which will be received by the SSD via its communication lane #1 pins for routing to its first memory space (NAND chips 1002_{1,1}-1002_{4,1}) via the first data storage controller 1004₁. Conversely, for plug 1116 and host socket 1118, if plug 1116 is inserted into socket 1118 with CC of the plug connected to CC1 of the host socket, the host will detect that orientation and route signals from socket 1118 onto communication lane #2 of the cable 110₁, which will be received by the SSD via its communication lane #2 pins for routing to its second memory space (NAND chips 1002_{1,2}-1002_{4,2}) via the second data storage controller 1004₂. If the plug 1116 is inserted into socket 1118 with CC of the plug connected to CC2 of that host socket, the host will detect that reverse orientation and again route signals from socket 1118 onto communication lane #2 of the cable 1101, which will be received by the SSD via its communication lane #2 pins for routing to its second memory space via the first data storage controller 1004₁.

A second configuration will now be described in which plug 1112 is instead connected to host socket 1118 with plug 1116 connected to host socket 1114. If the plug 1112 is inserted into socket 1118 with CC of the plug connected to CC1 of that host socket, the host will detect that orientation and route signals from socket 1118 onto communication lane #1 of the cable 1101, which will be received by the SSD via its communication lane #1 pins for routing to its first memory space (NAND chips 1002_{1,1}-1002_{4,1}) via the first data storage controller 1004₁. If the plug 1112 is inserted into socket 1118 with CC of the plug connected to CC2 of that host socket, the host will detect that reverse orientation and again route signals from socket 1118 onto communication lane #1 of the cable 1101, which will be received by the SSD via its communication lane #1 pins for routing to its first memory space via the first data storage controller 1004₁. Conversely, for plug 1116 and host socket 1114, if plug 1116 is inserted into socket 1114 with CC of the plug connected to CC1 of the host socket, the host will detect that orientation and route signals from socket 1116 onto communication lane #2 of the cable 1101, which will be received by the SSD via its communication lane #2 pins for routing to its second memory space via the second data storage controller 1004₂. If the plug 1116 is inserted into socket 1114 with CC of the plug connected to CC2 of that host socket, the host will detect that reverse orientation and again route signals from socket 1116 onto communication lane #2 of the cable 1101, which will be received by the SSD via its communication lane #2 pins for routing to its second memory space via the first data storage controller 1004₁.

Note that the host-side plugs each include one pair of D+/D-pins (and corresponding communication lines within the cable 1001). The D+/D-lines are used by USB 5 Gbps and USB 10 Gbps for backward compatibility with USB 2.0 and also used by the host during initial connection and enumeration. That is, during the initial connection process, the D+/D-pins are used to establish communication between the host and device. The SSD signals its presence and negotiates the connection speed (e.g., USB 2.0 or SuperSpeed) using these pins. Assuming both the host and device support SuperSpeed, the connection switches to the SuperSpeed differential pairs (TX/RX) after enumeration. Even in SuperSpeed mode, some control transfers (e.g., setup packets, device configuration) may still occur over the D+/D-lines using USB 2.0 protocols for compatibility. The D+/D-lines may be regarded as a third communication lane and data may be transferred over that lane in accordance with USB 2.0 at, for example, 12 Mbps or 480 Mbps. Moreover, although the first and second communication lanes of the cable are capable of transferring data using at least 5 Gbps, those lanes can transfer data at slower rates as well, such as 12 Mbps or 480 Mbps.

The three-plug cable described herein is referred to as an USB-C compatible cable because it is capable of handling data transfer in accordance with USB data transfer protocols without and modifications to the host. However, strictly-speaking, the three-plug cable may not conform to the USB standard because of the additional host side plug. Also, as explained, the first plug 1112 does not have the second communication lane lines/wires, and the second plug 1116 does not have the first communication lane lines/wires.

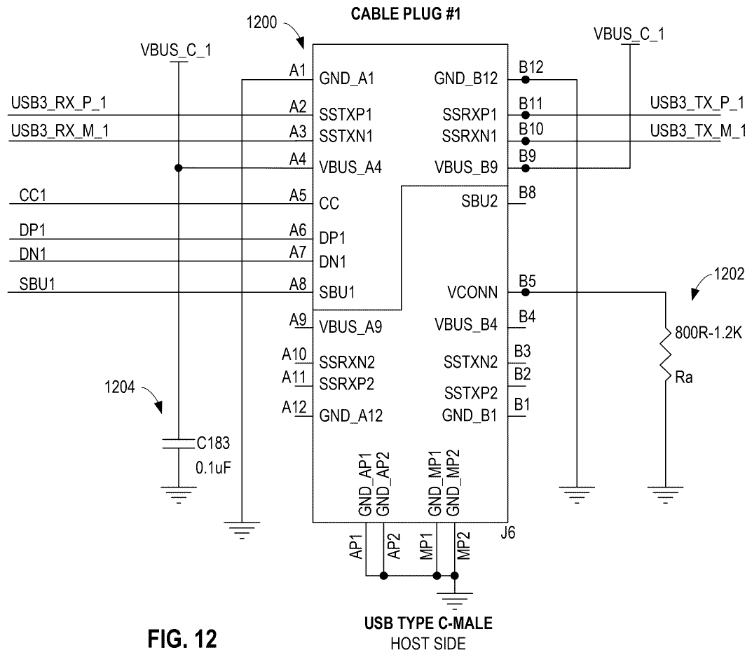

FIG. 12 is a circuit schematic of pertinent features of a host side plug 1200, which may correspond to plug 1112 of FIG. 11. In the example of FIG. 12, the plug 1200 is shown with its A5/CC pin connected to the CC1 pin of the corresponding host socket. If plug 1200 is inserted in the opposite orientation, then the A5/CC pin is instead connected to the CC2 pin of the corresponding host socket. Note that pins B1-B8 and A9-A12 of the plug 1200 are not connected via the cable to corresponding pins at the device-side plug, as explained above with respect to FIG. 11. Some of these pins are connected to ground, as shown. In particular, the VCONN pin B5 is connected to ground via an Ra resistor 1202, as shown, which is a component of the plug 1200. Note that within FIG. 12, for the sake of completeness, pins B1-B8 and A9-A12 are given their standard names (such as SSTXN2 and SSTXP2), but this does not mean that those pins are connected to the SSD device, as already explained. Also, within FIG. 12, some features of the host socket are shown, such as capacitor 1204. This is a standard feature of a host USB Type-C socket. As already explained, no changes are needed to the host socket or host operating system.

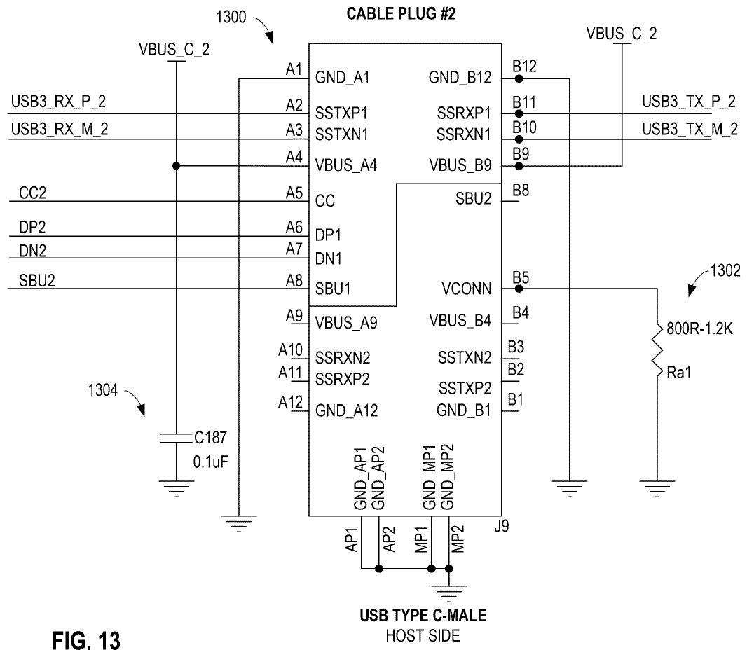

FIG. 13 is a circuit schematic of pertinent features of a host side plug 1300, which may correspond to plug 1116 of FIG. 11. Plug 1300 has the same physical configuration as plug 1200. In the example of FIG. 13, the plug 1300 is shown with its A5/CC pin connected to the CC2 pin of the corresponding host socket. If plug 1300 is inserted in the opposite orientation, then the A5/CC pin is instead connected to the CC2 pin of the corresponding host socket. Note, again, that pins B1-B8 and A9-A12 are not connected via the cable to corresponding pins at the device-side plug. Some of these pins are connected to ground, as shown. In particular, the VCONN pin B5 is connected to ground via an Ra resistor 1302, which is an internal component of the plug 1300. As with FIG. 12, the pins B1-B8 and A9-A12 of FIG. 13 are given their standard names (such as SSTXN2 and SSTXP2), but this does not mean that those pins are connected to the SSD device, as already explained. Also, within FIG. 13, some features of the host socket are again shown, such as capacitor 1304. As explained, no changes are needed to the host socket or host operating system.

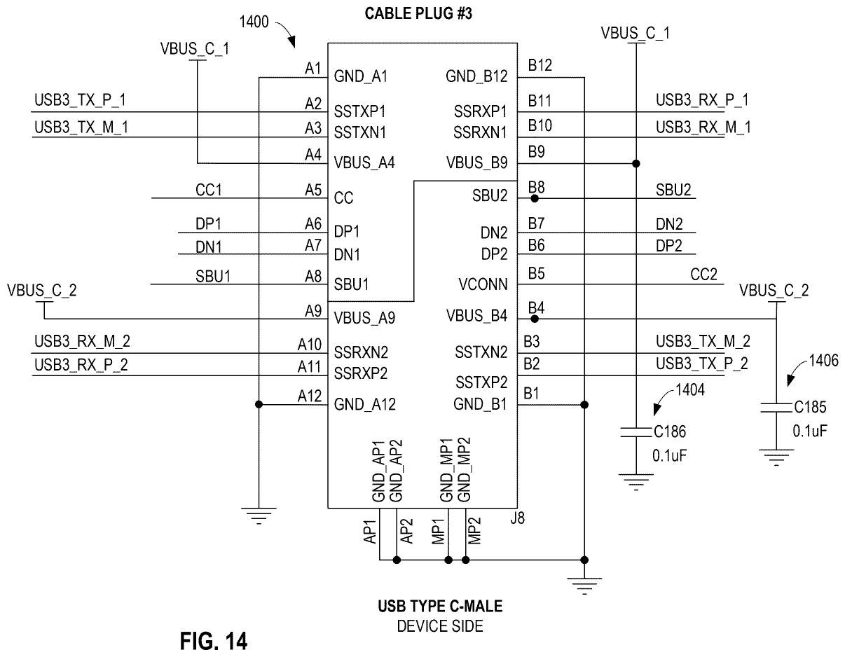

FIG. 14 is a circuit schematic of pertinent features of a device side plug 1400, which may correspond to plug 1103 of FIG. 11. In the example of FIG. 14, the plug 1400 is shown with its A5/CC pin connected to the CC1 pin of the corresponding device socket. If plug 1400 is inserted in the opposite orientation, then the A5/CC pin is instead connected to the CC2 pin of the corresponding device socket. Pins A1-A8 and B9-B12 of plug 1400 are connected to the corresponding pins (A1-A8 and B9-B12) in host side plug 1200. Pins B1-B8 and A9-A12 of plug 1400 are connected to pins (A1-A8 and B9-B12) of host side plug 1300. Also, within FIG. 14, some features of the device socket are shown, such as capacitors 1404 and 1406.

FIGS. 11-14 thus illustrate one exemplary embodiment of a three-plug USB Type-C cable. Other configurations are feasible. For example, the cable could instead be configured so that the communication lane #2 lines are connected to the A9-A12 and B1-B8 pins of cable plug #2 (plug 1116 of FIG. 11) with appropriate changes to the circuitry. In some embodiments, one or more of the (male) plugs could be replaced with (female) sockets or receptables for mating with a plug of a device, such as the plug of a thumb drive. Although described herein primarily with reference to SuperSpeed USB protocols (e.g., USB 3.1), aspects are applicable to USB4, which also uses Type-C connectors, though at half USB4 capacity, i.e., 10 Gbps per lane rather than 20 Gbps. Aspects disclosed herein are also applicable to Thunderbolt, which also uses Type-C connectors.

In some aspects, one or both of the host-side Type C plugs could be replaced with 9-pin Type A plugs, where, herein, a 9 pin Type-A plug refers to USB 3.0/3.1 Type-A, which has four legacy USB 2.0 pins and five SuperSpeed pins (for a total 9). Suitable modifications are made to the circuit schematics to connect the wiring of the 9-pin Type A plugs at the host side with the wiring of the Type C plug at the device side to allow the host to detect the device and to properly send and receive data. By way of example, since the Type-A port has no CC pin, the Type-C plug should include a 56 kΩ pull-up (Rp) from CC (A5) to VBUS to advertise “Default USB Type-C current” and let the Type C-device detect a host/source. In some aspects, one or both of the host-side Type C plugs could be replaced with 4-pin Type A plugs, where, herein, a 4 pin Type-A plug refers to USB 2.0 Type-A, which has four legacy USB 2.0 pins. Type-A 4 pin plugs cannot accommodate SuperSpeed. Suitable modifications are made to the circuit schematics to connect the wiring of the 4-pin Type A plugs at the host side with the wiring of the Type C plug at the device side to allow the host to detect the device and to properly send and receive data. Again, since a Type-A port has no CC pin, the Type-C plug should include a 56 kΩ pull-up (Rp) from CC (A5) to VBUS to let the Type C-device detect a host/source. In some aspects, an additional (fourth) plug may be provided so that the host side has three plugs and the cable provides three communication lanes, one of which would be limited to legacy USB 2.0.

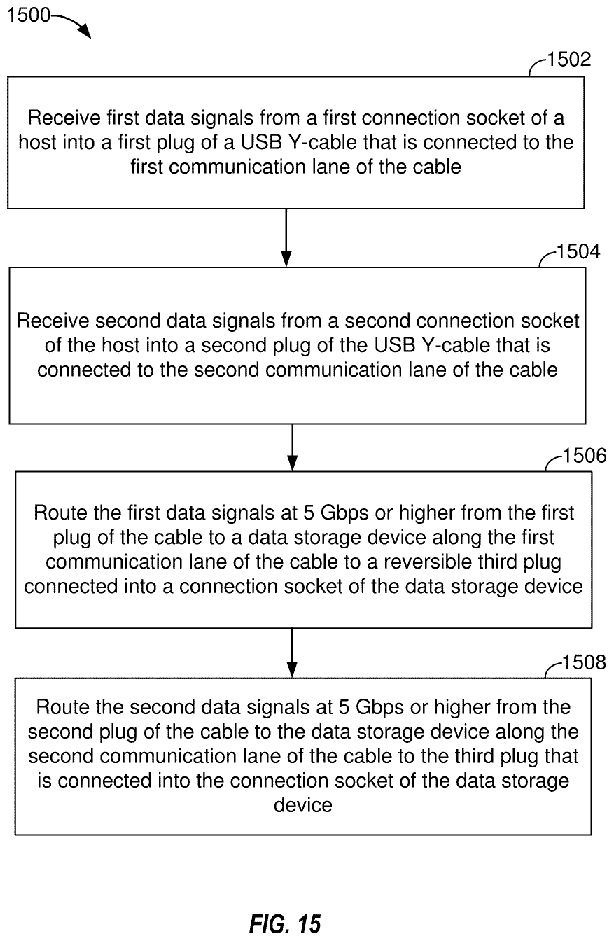

FIG. 15 illustrates a method 1500 for use by a connection cable to connect a data storage device to a host, wherein the connection cable includes first and second communication lanes, each configured for data transfer at 5 Gbps or higher in accordance with a USB protocol. At block 1502, first data signals are received from a first connection socket of the host into a first plug of the cable that is connected to the first communication lane of the cable. At block 1504, second data signals are received from a second connection socket of the host into a second plug of the cable that is connected to the second communication lane of the cable. At block 1506, the first data signals are route at 5 Gbps or higher from the first plug of the cable to the data storage device along the first communication lane of the cable to a third plug that is connected into a connection socket of the data storage device, the third plug being reversible. At block 1508, the second data signals are routed at 5 Gbps or higher from the second plug of the cable to the data storage device along the second communication lane of the cable to the third plug that is connected into the connection socket of the data storage device. In some examples, the first and second communication lanes route data concurrently at 5 Gbps or higher. In other examples, the first communication lane routes data at 5 Gbps while the second communication lane concurrently routes data at 10 Gbps.

### Additional Aspects

Aspects of the subject matter described herein can be implemented in any suitable NAND flash memory, such as 3D NAND flash memory. Semiconductor memory devices include volatile memory devices, such as DRAM) or SRAM devices, NVM devices, such as ReRAM, EEPROM, flash memory (which can also be considered a subset of EEPROM), ferroelectric random access memory (FRAM), and MRAM, and other semiconductor elements capable of storing information. See, also, 3D XPoint (3DXP)) memories. Each type of memory device may have different configurations. For example, flash memory devices may be configured in a NAND or a NOR configuration.

In addition to data storage devices, the NVM arrays (and associated circuitry and latches, where appropriate) in various described embodiments may be implemented as part of memory devices such as dual in-line memory modules (DIMMs) or other types of memory components/modules in some embodiments. Such memory devices may be accessible to a processing component such as a Central Processing Unit (CPU) or a Graphical Processing Unit (GPU). The links between processing components to such memory devices may be provided via one or more memory or system buses, including via interconnects such as Compute Express Link (CXL), Gen-Z, OpenCAPI, NVLink/NVSwitch, Infinity Fabric, Omni-Path, and other similar interconnect protocols. In other embodiments, the links between processing components to memory devices may be provided via on-die or die-to-die interconnects. In certain embodiments, the NVM arrays and associated circuitry may be co-located on the same die as the processing components such as CPU or GPU. In other examples, data may be stored in as hard disk drives (HDDs) or hybrid drives, etc.

Regarding the application of the features described herein to other memories besides NAND: NOR, 3DXP, PCM, and ReRAM have page-based architectures and programming processes that usually require operations such as shifts, XORs, ANDs, etc. If such devices do not already have latches (or their equivalents), latches can be added to support the latch-based operations described herein. Note also that latches can have a small footprint relative to the size of a memory array as one latch can connect to many thousands of cells, and hence adding latches does not typically require much circuit space.

The memory devices can be formed from passive and/or active elements, in any combination. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bitline and accessed as a group. Alternatively, memory elements may be configured so that each element is individually accessible, e.g., a NOR memory array. NAND and NOR memory configurations are exemplary, and memory elements may be otherwise configured. The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-y direction plane) which extends substantially parallel to a major surface of a substrate that supports the memory elements. The substrate may be a wafer over or in which the layer of the memory elements is formed or it may be a carrier substrate that is attached to the memory elements after they are formed. As a non-limiting example, the substrate may include a semiconductor such as silicon. The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bitlines and word lines.

A three-dimensional memory array is arranged so that memory elements occupy multiple planes or multiple memory device levels, thereby forming a structure in three dimensions (i.e., in the x, y and z directions, where the z direction is substantially perpendicular and the x and y directions are substantially parallel to the major surface of the substrate). As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the z direction) with each column having multiple memory elements in each column. The columns may be arranged in a two-dimensional configuration, e.g., in an x-y plane, resulting in a three-dimensional arrangement of memory elements with elements on multiple vertically stacked memory planes. Other configurations of memory elements in three dimensions can also constitute a three-dimensional memory array.

By way of a non-limiting example, in a three-dimensional NAND memory array, the memory elements may be coupled together to form a NAND string within a single horizontal (e.g., x-y) memory device level. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements that span through multiple memory levels. Three-dimensional memory arrays may also be designed in a NOR configuration and a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two-dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements. One of skill in the art will recognize that the subject matter described herein is not limited to the two-dimensional and three-dimensional exemplary structures described but covers all relevant memory structures within the spirit and scope of the subject matter as described herein and as understood by one of skill in the art.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatus, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer-readable medium having stored thereon computer-executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application-specific integrated circuits. In addition, a computer-readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” is intended to cover A, B, C, A-B, A-C, B-C, and A-B-C, as well as multiples of the same members (e.g., any lists that include AA, BB, or CC). Likewise, “at least one of: A, B, and C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

As used herein, the term “determining” encompasses a wide variety of actions. For example, “determining” may include calculating, computing, processing, deriving, investigating, looking up (e.g., looking up in a table, a database, datastore, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A cable for connecting a data storage device to a host, the cable comprising:
first and second communication lanes, each configured for data transfer at 5 giga-bits-per-second (Gbps) or higher in accordance with a Universal Serial Bus (USB) protocol;
a first plug connected to the first communication lane for insertion into a first connection socket of the host;
a second plug connected to the second communication lane for insertion into a second connection socket of the host; and
a third plug connected to both the first and second communication lanes for insertion into a connection socket of the data storage device, the third plug being reversible.

2. The cable of claim 1, wherein the USB protocol is USB 5 Gbps or USB 10 Gbps.

3. The cable of claim 1, further configured for data transference in accordance with USB 2.0 at 12 mega-bits-per-second (Mbps) or 480 Mbps.

4. The cable of claim 1, wherein the first plug is either a USB Type-A plug or a USB Type-C plug.

5. The cable of claim 1, wherein the first plug is a USB Type-A plug and the second plug is a USB Type-C plug.

6. The cable of claim 1, wherein the third plug is a USB Type-C plug.

7. The cable of claim 1, wherein the cable is a passive cable.

8. The cable of claim 1, wherein:
the first communication lane is coupled to a configuration channel (CC) pin within the first plug for connecting to a corresponding pin in the first connection socket of the host and is coupled to a device-side configuration channel (CC) pin within the third plug for connecting to a first configuration channel (CC1) pin in the connection socket of the data storage device; and
the second communication lane is coupled to a configuration channel (CC) pin within the second plug for connecting to a corresponding pin in the second connection socket of the host and is coupled to a device-side VCONN pin within the third plug for connecting to a second configuration channel (CC2) pin in the connection socket of the data storage device.

9. The cable of claim 8, wherein:
connection pins of the first plug are configured to notify the host to enable the first communication lane between the first connection socket of the host and the connection socket of the data storage device; and
connection pins of the second plug are configured to notify the host to enable the second communication lane between the second connection socket of the host and the connection socket of the data storage device.

10. The cable of claim 9, wherein:
the first plug comprises a pull-down (Ra) resistor configured to pull down the voltage of a VCONN pin of the first connection socket of the host while the cable is in use; and
the second plug comprises a pull-down (Ra) resistor configured to pull down the voltage of a VCONN pin of the second connection socket of the host while the cable is in use.

11. The cable of claim 1, wherein the third plug is configured with first and second matching pairs of universal serial bus (USB) D+/D− pins, with the first pair connected to the first communication lane and the second pair connected to the second communication lane.

12. The cable of claim 1, wherein the cable is configured to deliver power from the host to the data storage device from both the first and second connection sockets.

13. A system comprising:
the cable of claim 1, and
the data storage device of claim 1, wherein the data storage device comprises:
a first data storage controller coupled to a first memory and coupled to the connection socket of the data storage device for enabling data transfer with the host along the first communication lane using the first connection socket of the host; and
a second data storage controller coupled to a second memory and coupled to the connection socket of the data storage device for enabling data transfer with the host along the second communication lane using the second connection socket of the host.

14. The system of claim 13, wherein the first memory comprises a first plurality of NAND chips, and wherein the second memory comprises a second plurality of NAND chips.

15. The system of claim 14, wherein each of the plurality of NAND chips is configured to store two terabytes (TB) of data.

16. The system of claim 13, wherein the first memory comprises a first plurality of dynamic random access memory (DRAM) chips, and wherein the second memory comprises a second plurality of DRAM chips.

17. The system of claim 13, wherein the data storage device comprises one or more of a hard disk drive (HDD), a solid state drive (SSD), a hybrid SSD/HDD drive, or a USB drive.

18. A method for use by a connection cable to connect a data storage device to a host, wherein the connection cable includes first and second communication lanes, each configured for data transfer at 5 giga-bits-per-second (Gbps) or higher in accordance with a universal serial bus (USB) protocol, the method comprising:
receiving first data signals from a first connection socket of the host into a first plug of the cable that is connected to the first communication lane of the cable;
receiving second data signals from a second connection socket of the host into a second plug of the cable that is connected to the second communication lane of the cable;
routing the first data signals at 5 Gbps or higher from the first plug of the cable to the data storage device along the first communication lane of the cable to a third plug that is connected into a connection socket of the data storage device, the third plug being reversible; and
routing the second data signals at 5 Gbps or higher from the second plug of the cable to the data storage device along the second communication lane of the cable to the third plug that is connected into the connection socket of the data storage device.

19. The method of claim 18, wherein the first and second communication lanes route data concurrently at 5 Gbps or higher.

20. The method of claim 18, wherein the first communication lane routes data at 5 Gbps while the second communication lane concurrently routes data at 10 Gbps.

21. The method of claim 18, further comprising routing data along a third communication lane at 12 mega-bits-per-second (Mbps) or 480 Mbps in accordance with USB 2.0.

22. A connection cable for connecting a data storage device to a host, the connection cable comprising:
means for receiving first data signals from a first connection socket of the host;
means for receiving second data signals from a second connection socket of the host;
means for transferring the first data signals along the connection cable at 5 giga-bits-per-second (Gbps) or higher in accordance with a universal serial bus (USB) protocol;
means for transferring the second data signals along the connection cable at 5 Gbps or higher in accordance with the USB protocol; and
means for transferring the first and second data signals into a connection socket of the data storage device.
